(19) United States
(12) Patent Application Publication
(10) Pub. No.: US 2012/0031217 A1
(43) Pub. Date: Feb. 9, 2012

(54) ROBOTIC ARM

(75) Inventors: JIAN-PING JIN, Shenzhen (CN); LI-HUA ZHANG, Shenzhen (CN); KE ZHOU, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/913,942

(22) Filed: Oct. 28, 2010

(30) Foreign Application Priority Data
Aug. 9, 2010 (CN) 201010248385.5

(51) Int. Cl. B25J 18/00

(52) U.S. Cl. 74/490.01

(57) ABSTRACT

A robotic arm is for holding a molded item. The robotic arm includes a mount; a first horizontal driving device movably mounted to the mount in a first direction; a mounting board mounted to the first horizontal driving device; a second horizontal driving device including a seat mounted to the mounting board, a gear rotatably mounted to the seat, a toothed rack engaging the gear and a motor driving the gear to rotate relative to the seat; and a holder for holding the molded item, the holder mounted to the toothed rack. The first horizontal driving device drives the mounting board to move in a second direction perpendicular to the first direction, the gear rotates to drive the toothed rack to move in a third direction perpendicular to the first direction and the second direction.

### CROSS-REFERENCE TO RELATED APPLICATIONS

This application is related to co-pending U.S. Patent Applications (Attorney Docket No. US34532 and US 34534), entitled “ROBOTIC ARM”, by Jin et al. These application have the same assignee as the present application and have been concurrently filed herewith. The above-identified applications are incorporated herein by reference.

### BACKGROUND

1. Technical Field

This disclosure relates to robotic arms, particularly to robotic arms for handling freshly molded items

2. Description of Related Art

Molding machines typically use robotic arms to hold molded items. However, typical robotic arms have a complicated mechanism.

Therefore, there is a room for improved in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary robotic arm. Moreover, in the drawings like reference numerals designate corresponding parts throughout the several views. Wherever possible, the same reference numbers are used throughout the drawings to refer to the same or like elements of an embodiment.

FIG. 1 is an assembled view of an exemplary embodiment of a robotic arm.

FIG. 2 is another assembled view of the robotic arm shown in FIG. 1.

FIG. 3 is an exploded view of the robotic arm shown in FIG. 1.

FIG. 4 is an exploded view of the robotic arm shown in FIG. 2.

### DETAILED DESCRIPTION

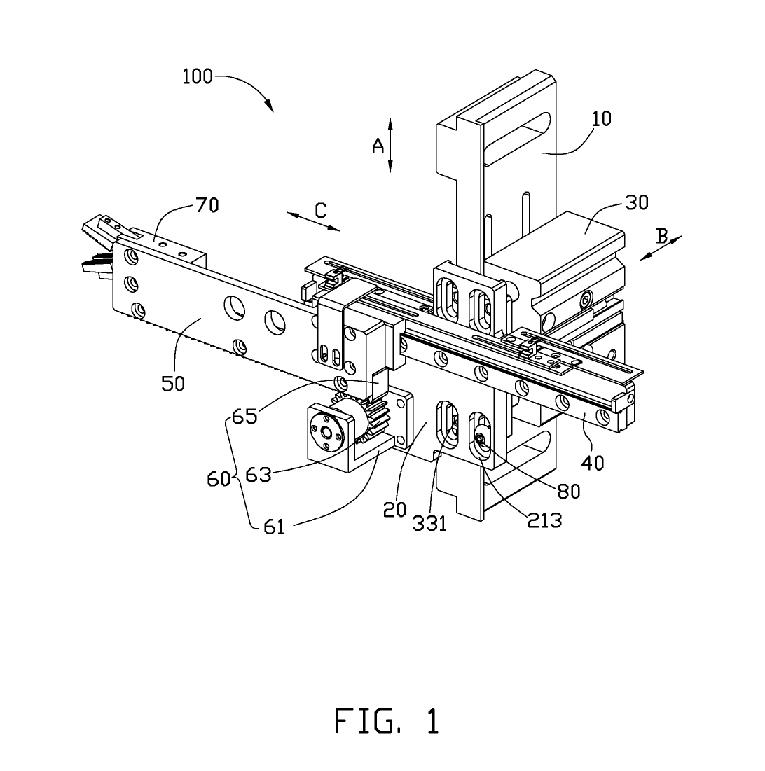

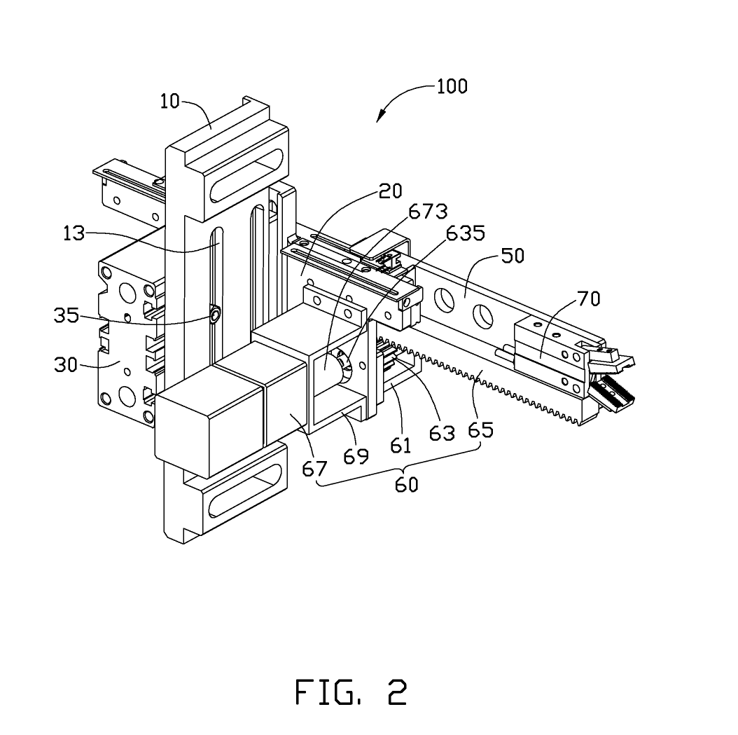

Referring to FIGS. 1-2, an exemplary robotic arm 100 used in a molding machine (not shown) is disclosed. The robotic arm 100 can extend into the molding machine for holding and reto move molded items (not shown) in the molding machine.

The robotic arm 100 includes a mount 10, a mounting board 20, a lifting mechanism (not labeled), a first horizontal driving device 30, a sliding mechanism 40, a connecting board 50, a second horizontal driving device 60 and a holder 70. The lifting mechanism is mounted between the mount 10 and the first horizontal driving device 30. The mounting board 20 is mounted to the first horizontal driving device 30. The lifting mechanism is used to mechanically raise or lower the first horizontal driving device 30 relative to the mount 10 so the mounting board 20 can move in a first (e.g., vertical) direction A shown in FIG. 1. The first horizontal driving device 30 is mounted between the mount 10 and the mounting board 20 to move the mounting board 20 relative to the mount 10 in a second (first horizontal) direction B shown in FIG. 1 perpendicular to the first direction A. The sliding mechanism 40 is mounted between the mounting board 20 and the connecting board 50 to control the connecting board 50 move relative to the mounting board 20 in a third (e.g., second horizontal) direction C shown in FIG. 1 perpendicular to the first direction A and the second direction B. The second horizontal driving device 60 is mounted between the mounting board 20 and the connecting board 50 to enable the connecting board 50 to move relative to the mounting board 20 in the second direction B. The holder 70 is mounted to a distal end of the connecting board 50 and moves with the connecting board 50 relative to the mounting board 20, for holding and reto move molded items in the molding machine.

Referring to FIG. 2, the lifting mechanism includes a guiding groove 13 and a pin 35 movably engaging with the guiding groove 13. In this exemplary embodiment, the guiding groove 13 is defined in the mount 10 and the pin 35 is positioned on the first horizontal driving device 30. When the first horizontal driving device 30 moves relative to the mount 10 in the first direction A, the pin 35 moves in the guiding groove 13.

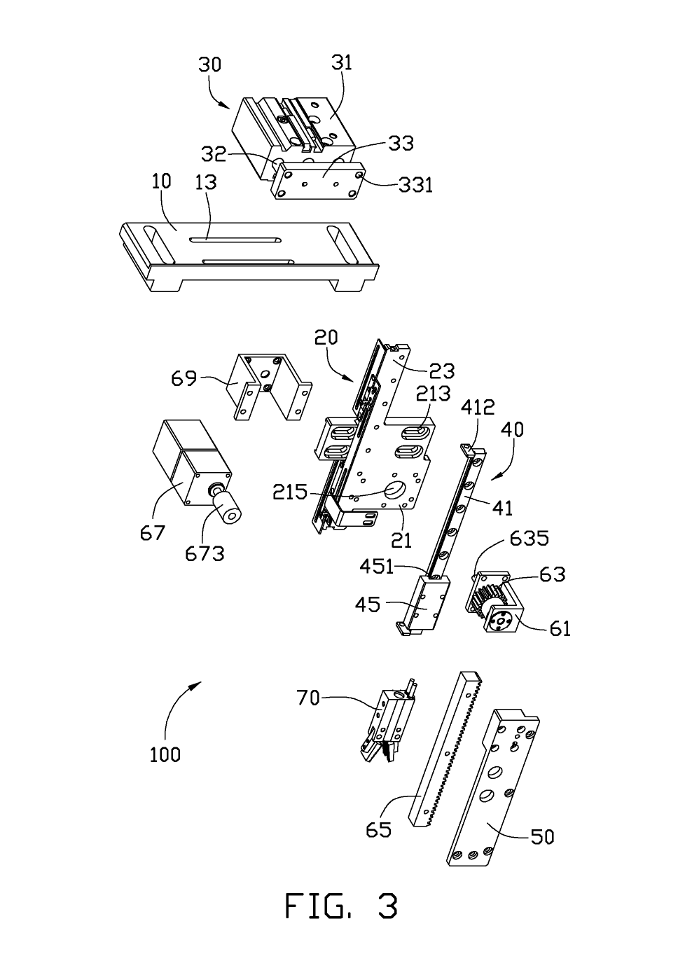

Referring to FIGS. 1 and 3, the first horizontal driving device 30 includes a cylinder 31, an output rod 32 movably mounted on the cylinder 31 and a retaining board 33 mounted on a distal end of the output rod 32 for retaining the mounting board 20 to the first horizontal driving device 30. The retaining board 33 defines a number of retaining holes 331 for mounting the mounting board 20 to the retaining board 33. When the output rod 32 moves relative to the cylinder 31, the retaining board 33 drives the mounting board 20 to move relative to the mount 10 and the first horizontal driving device 30 in the second direction B.

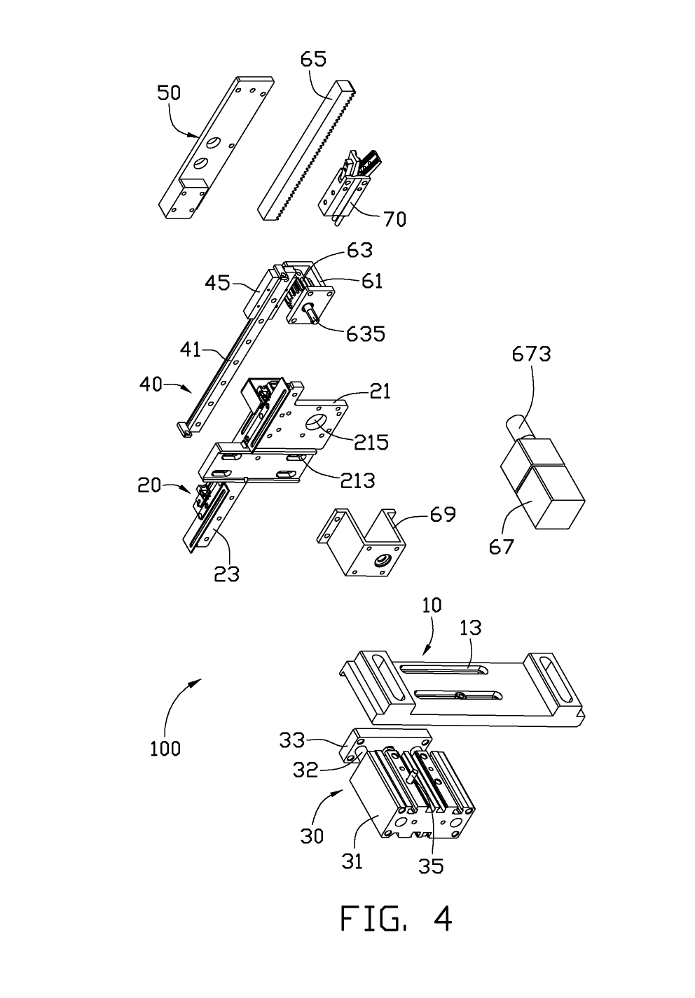

Referring to FIGS. 3 and 4, the mounting board 20 includes a main body 21 and a mounting arm 23 located near one side of the main body 21. The mounting board 20 defines a number of mounting holes 213 in the main body 21. Each mounting hole 213 corresponds to one of the retaining holes 331 for mounting the mounting board 20 to the retaining board 33. The mounting board 20 further defines an opening 215 through the main body 21 for the second horizontal driving device 60 to pass through the mounting board 20.

Referring to FIGS. 1 and 3, the sliding mechanism 40 is mounted between the mounting board 20 and the connecting board 50 to make the connecting board 50 move relative to the mounting board 20. The sliding mechanism 40 includes a rail 41 and a sliding block 45, the rail 41 movably engages with a sliding groove 451 defined in the sliding block 45. In this exemplary embodiment, the rail 41 is positioned on the mounting arm 23 and the sliding block 45 is positioned on connecting board 50, so the connecting board 50 can move relative to the mounting board 20 along the rail 41. The sliding mechanism 40 further includes two stopping blocks 412 respectively positioned near opposite ends of the rail 41. The stopping blocks 412 are used for preventing the sliding block 45 and the rail 41 from separating.

Referring to FIGS. 1 and 3, the second horizontal driving device 60 includes a seat 61 mounted to one side of the mounting board 20, a gear 63 rotatably mounted on the seat 61 by a shaft 635, a toothed rack 65 mounted to the connecting board 50, a chassis 69 mounted to another side of the mounting board 20 and a motor 67 mounted to the chassis 69. The motor 67 includes a driving pole 673 passing through the opening 215 to connect with the shaft 635. The driving pole 673 drives the shaft 635 to rotate relative to the seat 61. The gear 63 engages with the toothed rack 65. Therefore, when the gear 63 rotates, the gear 63 drives the toothed rack 65 to move relative to the gear 63. Additionally, the toothed rack 65 is mounted to the connecting board 50 so when the gear 63 rotates, the connecting board 50 can move together with the toothed rack 65.

Referring to FIGS. 2 and 4, in assembly, the pin 35 is mounted in the guiding groove 13 to slidably mount the first horizontal driving device 30 to the mount 10. The retaining holes 331 are respectively aligned with the mounting holes 213 and then a number of bolts 80 (FIG. 1) are inserted in the retaining holes 331 and the mounting holes 213 to retain the mounting board 20 to the retaining board 33. Referring to FIGS. 1 and 2, the seat 61 is mounted to the mounting board 20 with the shaft 635 aligned with the opening 215, the chassis 69 is mounted to the mounting board 20 with the driving pole 673 passing through the opening 215 to connect with the shaft 635. The rail 41 is mounted to mounting board 20 and the sliding block 45 is slidably mounted to the rail 41. The holder 70 is retained to the connecting board 50. The toothed rack 65 is retained to the connecting board 50. The connecting board 50 is mounted to the sliding block 45 with the toothed rack 65 engaging with the gear 63, to yield an assembled robotic arm 100.

Referring to FIG. 1, in use, the first horizontal driving device 30 moves relative to the mount 10 by the lifting mechanism, to adjust the distance between the holder 70 and the molding machine in the first direction A. To adjust the distance between the holder 70 and the molding machine in the second direction B, the cylinder 31 is started to drive the mounting board 20 to move relative to the cylinder 31 until the holder 70 moves to a first predetermined position. To adjust the distance between the holder 70 and the molding machine in the third direction C, the motor 67 is started to drive the gear 63 to rotate so the toothed rack 65 moves until the holder 70 arrives in a second predetermined position.

It is to be understood that the sliding mechanism 40 and the connecting board 50 may be omitted, in this case, the holder 70 is directly mounted to the toothed rack 65; the toothed rack 65 is slidably and directly mounted to the mounting board 20. Thus, the motor 67 drives the gear 63 to rotate so the toothed rack 65 moves relative to the mounting board 30 in the third direction C. It is also to be understood that the mounting board 20 can be directly and slidably mounted to the mount 10, and the lifting mechanism can be omitted.

It is to be further understood that even though numerous characteristics and advantages of the exemplary embodiments have been set forth in the foregoing description, together with details of structures and functions of various embodiments, the disclosure is illustrative only, and changes may be made in detail, especially in matters of shape, size, and arrangement of parts within the principles of the exemplary invention to the full extent indicated by the broad general meaning of the terms in which the appended claims are expressed.

What is claimed is:

1. A robotic arm for holding a molded item, the robotic arm comprising:
a mount;
a first horizontal driving device movably mounted to the mount in a first direction;
a mounting board mounted to the first horizontal driving device;
a second horizontal driving device including a seat mounted to the mounting board, a gear rotatably mounted to the seat, a toothed rack engaging the gear and a motor driving the gear to rotate relative to the seat; and
a holder for holding the molded item, the holder mounted to the toothed rack;
wherein the first horizontal driving device drives the mounting board to move in a second direction perpendicular to the first direction, the gear rotates to drive the toothed rack to move in a third direction perpendicular to the first direction and the second direction.

2. The robotic arm of claim 1, further including a lifting mechanism coupled between the mount and the first horizontal driving device for the first horizontal driving device to move relative to the mount in the first direction.

3. The robotic arm of claim 2, wherein the lifting mechanism includes a guiding groove and a pin movably engaging with the guiding groove.

4. The robotic arm of claim 3, wherein the guiding groove is defined in the mount and the pin is positioned on the first horizontal driving device.

5. The robotic arm of claim 4, wherein when the first horizontal driving device moves relative to the mount in the first direction, the pin moves in the guiding groove.

6. The robotic arm of claim 1, wherein the first horizontal driving device includes a cylinder, an output rod movably mounted on the cylinder and a retaining board mounted on a distal end of the output rod; the retaining board is mounted to the mounting board to retain the mounting board to the first horizontal driving device.

7. The robotic arm of claim 6, wherein when the output rod moves relative to the cylinder, the retaining board drives the mounting board to move relative to the mount and the first horizontal driving device in the second direction.

8. The robotic arm of claim 1, further including a connecting board, both the holder and the toothed rack mounted to the connecting board.

9. The robotic arm of claim 8, further including a sliding mechanism mounted between the mounting board and the connecting board; the sliding mechanism moves the connecting board relative to the mounting board.

10. The robotic arm of claim 9, wherein the sliding mechanism includes a rail positioned on the mounting board and a sliding block positioned on connecting board; and the rail movably engaging with a sliding groove defined in the sliding block so the connecting board can move relative to the mounting board along the rail.

11. The robotic arm of claim 10, wherein two stopping blocks respectively positioned near opposite ends of the rail, the stopping blocks are for prevent the sliding block and the rail from separating.

12. The robotic arm of claim 1, wherein the gear is ratatably mounted on the seat by a shaft.

13. The robotic arm of claim 12, wherein the motor includes a driving pole connecting with the shaft and driving the shaft to rotate relative to the seat.

14. A robotic arm for holding a molded item, the robotic arm comprising:
a mount;
a mounting board;
a first horizontal driving device movably mounted to the mount in a first direction, the mounting board mounted to the first horizontal driving device, the first horizontal driving device drives the mounting board to move in a second direction perpendicular to the first direction;
a connecting board;
a sliding mechanism mounted between the mounting board and the connecting board so the connecting board can move relative to the mounting board in a third direction perpendicular to the first direction and the second direction;
a second horizontal driving device driving the connecting board to move relative to the mounting board in the third direction; and
a holder for holding the molded item, the holder mounted the connecting board.

15. The robotic arm of claim 14, wherein the second horizontal driving device including a seat mounted to the mounting board, a gear rotatably mounted to the seat, a toothed rack engaging the gear and a motor driving the gear to rotate relative to the seat.

16. The robotic arm of claim 14, further including a lifting mechanism coupled between the mount and the first horizontal driving device for the first horizontal driving device to move relative to the mount in the first direction.

17. The robotic arm of claim 16, wherein the lifting mechanism includes a guiding groove and a pin movably engaging the guiding groove.

18. The robotic arm of claim 17, wherein the guiding groove is defined in the mount and the pin is positioned on the first horizontal driving device.

19. The robotic arm of claim 18, wherein when the first horizontal driving device moves relative to the mount in the first direction, the pin moves in the guiding groove.

20. The robotic arm of claim 14, wherein the first horizontal driving device includes a cylinder, an output rod movably mounted on the cylinder and a retaining board mounted on a distal end of the output rod; the retaining board is mounted to the mounting board to retain the mounting board to the first horizontal driving device.
